(19) United States
(12) Patent Application Publication
(10) Pub. No.: US 2014/0102111 A1
(43) Pub. Date: Apr. 17, 2014

(54) Systems and Methods for Distributing Torque Contribution

(71) Applicant: GENERAL ELECTRIC COMPANY, Schenectady, NY (US)

(72) Inventor: Justin Aaron Allen, Greenville, SC (US)

(73) Assignee: GENERAL ELECTRIC COMPANY, Schenectady, NY (US)

(21) Appl. No.: 13/652,993

(22) Filed: Oct. 16, 2012

(51) Int. Cl. F02C 9/00

(52) U.S. Cl. 60/773; 60/793

(57) ABSTRACT

Systems and methods for distributing torque contribution are provided. According to one embodiment, a system may include a controller and a processor communicatively coupled to the controller. The processor may be configured to receive initial and final transition speeds of the drivetrain, receive a torque reference for accelerating the drivetrain, provide the starting device with primary control of the acceleration of the drivetrain according to the torque reference, and determine that the initial transition speed is reached. Based on the determination, the processor may capture initial transitional conditions of the starting device, define a torque trajectory of the starting device based on the initial and final transition speeds of the drivetrain, and transfer the primary control of the acceleration of the drivetrain from the starting device to the gas turbine.

### TECHNICAL FIELD

This disclosure relates generally to turbines, and more particularly, to systems and methods for distributing torque contribution between a gas turbine and a starting device.

### BACKGROUND

Conventionally, gas turbine operations are initiated with a starting device (e.g., a motor, a load commutated inverter, and a torque converter) providing torque to the drivetrain of the turbine. At the ignition speed of the drivetrain, the turbine is ignited but the starting device may continue contributing to the acceleration of the turbine until the turbine reaches a self-sustaining speed and becomes a major torque contributor. Thereafter, the turbine can accelerate itself to an operating speed.

During the turbine startup process, it is important to ensure smooth and timely acceleration of the drivetrain according to a predetermined startup schedule as torque contributions from the starting device and the turbine continuously change. However, because each of these two devices has its own operating window limitations (i.e. neither can handle acceleration control from start to full speed independently), smooth and timely acceleration of the drivetrain may be difficult to achieve. Traditionally, both the starting device and the gas turbine are provided with fixed acceleration schedules based on historical data collected under various ambient conditions.

However, real-life changes in operating parameters during the startup process may cause wide variations during the startup process. As no dynamic adjustments occur during the startup process, various deviations from the intended acceleration path may result in the inability to maintain a smooth, efficient and/or timely startup. Thus, the gas turbine may not meet operational requirements during the startup.

### BRIEF DESCRIPTION OF THE DISCLOSURE

The present disclosure relates to systems and methods for distributing torque contribution between a gas turbine and a starting device. According to one embodiment, a system may be provided. The system may include a controller and a processor communicatively coupled to the controller. The processor may be configured to receive an initial transition speed and a final transition speed of the drivetrain, receive a torque reference for accelerating the drivetrain, provide the starting device with primary control of the acceleration of the drivetrain according to the torque reference, and determine that the initial transition speed is reached. Based on the determination, initial transitional conditions of the starting device may be captured. Using the initial transitional conditions and the final transition speed of the drivetrain, a torque trajectory of the starting device may be defined. The starting device torque trajectory may be designed to eliminate torque contribution of the starting device when the final transition speed of the drivetrain is reached. Additionally a controller may be configured to transfer the primary control of the acceleration of the drivetrain from the starting device to the gas turbine, with the starting device following the torque trajectory while the gas turbine maintains the primary control of the acceleration according to the torque reference.

In another embodiment, a method can be provided. The method may include receiving an initial transition speed and a final transition speed of the drivetrain, receiving a torque reference for accelerating the drivetrain, providing the starting device with primary control of the acceleration, with the acceleration to be conducted according to the torque reference, and determining that the initial transition speed is reached. Based on the determination, initial transitional conditions of the starting device may be captured. Using the initial transitional conditions and the final transition speed of the drivetrain, a torque trajectory of the starting device may be defined. The starting device torque trajectory may be designed to eliminate torque contribution of the starting device when the final transition speed of the drivetrain is reached. Thereafter, the primary control of the acceleration of the drivetrain may be transferred from the starting device to the gas turbine, with the starting device following the torque trajectory while the gas turbine maintains the primary control of the acceleration according to the torque reference.

In yet another, a further system can be provided. The system can include a gas turbine, a starting device coupled to the gas turbine, a controller configured to control the gas turbine, and a processor coupled to the controller. The processor may be configured to receive an initial transition speed and a final transition speed of the drivetrain, receive a torque reference for accelerating the drivetrain, provide the starting device with primary control of the acceleration of the drivetrain according to the torque reference, and determine that the initial transition speed is reached. Based on the determination, initial transitional conditions of the starting device may be captured. Using the initial transitional conditions and the final transition speed of the drivetrain, a torque trajectory of the starting device may be defined as a polynomial function. The starting device torque trajectory may be designed to eliminate torque contribution of the starting device when the final transition speed of the drivetrain is reached. Additionally, the processor may be configured to transfer the primary control of the acceleration of the drivetrain from the starting device to the gas turbine, with the starting device following the torque trajectory while the gas turbine maintains the primary control of the acceleration according to the torque reference.

Other embodiments and aspects will become apparent from the following description taken in conjunction with the following drawings.

### BRIEF DESCRIPTION OF THE DRAWINGS

FIG. 1 is a block diagram illustrating an environment and a system, in accordance with an embodiment of the disclosure.

FIG. 2 illustrates a method for distributing torque contribution, in accordance with an embodiment of the disclosure.

FIG. 3 illustrates method for distributing torque contribution, in accordance with an embodiment of the disclosure.

FIG. 4 illustrates a gas turbine acceleration path, in accordance with an embodiment of the disclosure.

FIG. 5 illustrates an overall torque path, in accordance with an embodiment of the disclosure.

FIG. 6 illustrates overall and starting device torque paths during the transition portion of a gas turbine startup, in accordance with an embodiment of the disclosure.

FIG. 7 depicts a block diagram illustrating a controller for controlling a turbine, in accordance with an embodiment of the disclosure.

### DETAILED DESCRIPTION

The following detailed description includes references to the accompanying drawings, which form part of the detailed description. The drawings depict illustrations in accordance with example embodiments. These example embodiments, which are also referred to herein as “examples,” are described in enough detail to enable those skilled in the art to practice the present subject matter. The example embodiments may be combined, other embodiments may be utilized, or structural, logical, and electrical changes may be made, without departing from the scope of the claimed subject matter. The following detailed description is, therefore, not to be taken in a limiting sense, and the scope is defined by the appended claims and their equivalents.

The embodiments described herein relate to systems and methods for distributing torque contribution between a gas turbine and a starting device during acceleration of a drivetrain. During a turbine startup, initial acceleration is provided by a starting device, such as a motor, a load commutated inverter, a torque converter, and so forth.

When the speed of the turbine drivetrain reaches a certain speed defined as an initial transition speed, the turbine may start contributing to the overall torque so that at the end of the transition, the starting device contribution to the overall torque can be eliminated. To define a torque trajectory of the starting device, initial transitional conditions can be captured. The torque trajectory may be determined by a mathematical function based on the captured initial transitional conditions and desired final parameters (e.g., defined by an operator) of the torque trajectory of the starting device. The function can be, for example, a polynomial function of the third order. If this is the case, four boundary conditions may be obtained from initial and final torque contributions of the starting device and their derivatives with respect to drivetrain speed to determine coefficients of the polynomial function of the third order.

When the initial transition speed is reached, the primary control of the acceleration of the drivetrain can be transferred from the starting device to the gas turbine. During this transition phase, the turbine may be in full acceleration control by adjusting fuel to keep the overall torque according to the predetermined torque reference as the torque contribution of the starting device follows the trajectory defined by the polynomial. Once the final transition speed is reached, the starting device torque contribution may be eliminated completely and the turbine can continue accelerating the drivetrain to full speed.

The technical effects of certain embodiments of the disclosure may include dynamically distributing torque contribution between a gas turbine and a starting device during acceleration of a drivetrain of a gas turbine. Additionally, technical effects of certain embodiments of the disclosure may include smooth, efficient, and/or timely transition between torque contributions of the starting device and gas turbine, while avoiding open-loop adjustments to control parameters and, consequently, eliminating associated extensive field testing and validation in order to properly account for the factors that can affect startup predictability.

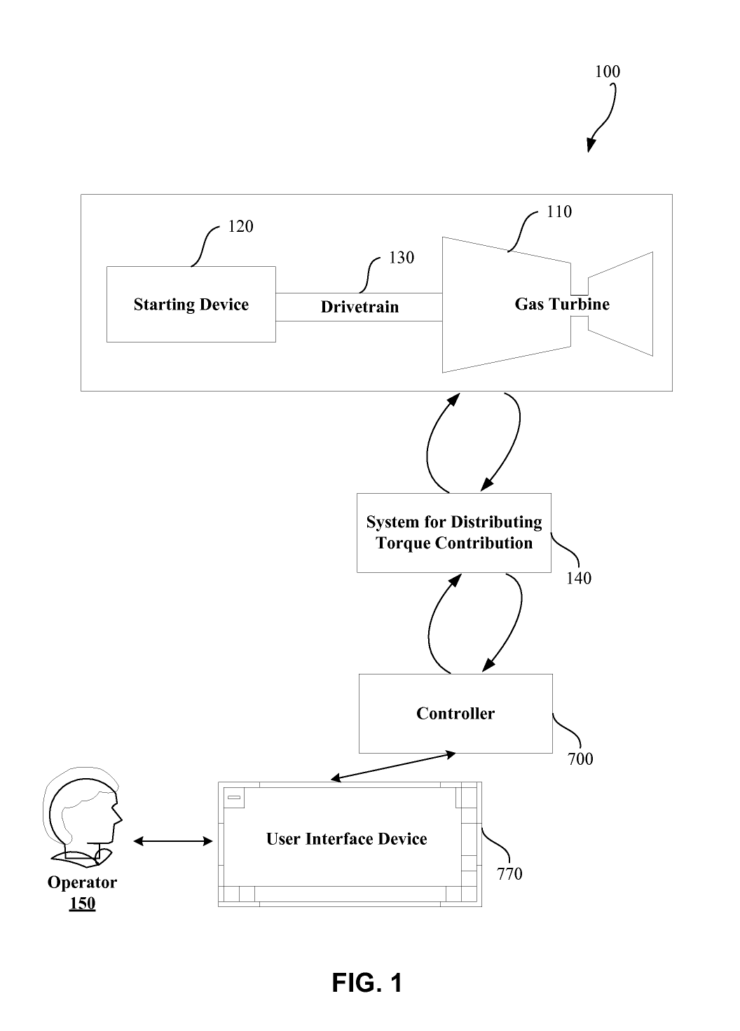

Referring now to FIG. 1, a block diagram illustrates a system environment 100 suitable for implementing a method for distributing torque contribution, in accordance with one or more example embodiments. In particular, the system environment 100 may comprise a gas turbine 110, starting device 120, drivetrain 130, controller 700, system for distributing torque contribution 140, user interface device 770, and operator 150. The operator 150 may interact with the system environment, particularly via the user interface device 770.

The gas turbine 110 may be coupled to the starting device 120 by the drivetrain 130. The starting device 120 may comprise a motor, a load commutated inverter, a torque converter, and so forth. The starting device 120 may provide torque to accelerate the gas turbine 110. The torque may be applied to the gas turbine 110 via the drivetrain 130 (e.g., a shaft).

Operations of the gas turbine 110 may be managed through the controller 700. The controller 700 may interact with the system for distributing torque contribution 140 to provide initial and final transition speeds of the drivetrain, provide a torque reference for accelerating the drivetrain, determine that the initial transition speed is reached, capture initial transitional conditions of the starting device, define a torque trajectory of the starting device to eliminate torque contribution of the starting device when the final transition speed of the drivetrain is reached, and transfer the primary control of the acceleration of the drivetrain from the starting device to the gas turbine. The controller may also be coupled to the starting device 120 to manage its operation and receive operational data from the starting device 120.

The operator 150 may interact with the controller 700 and the system for distributing torque contribution via the user interface device 770, such as a keyboard, mouse, control panel, or any other device capable of communicating data to and from the controller 700. Additionally, the operator 150 may specify initial and final transition speeds of the drivetrain 130.

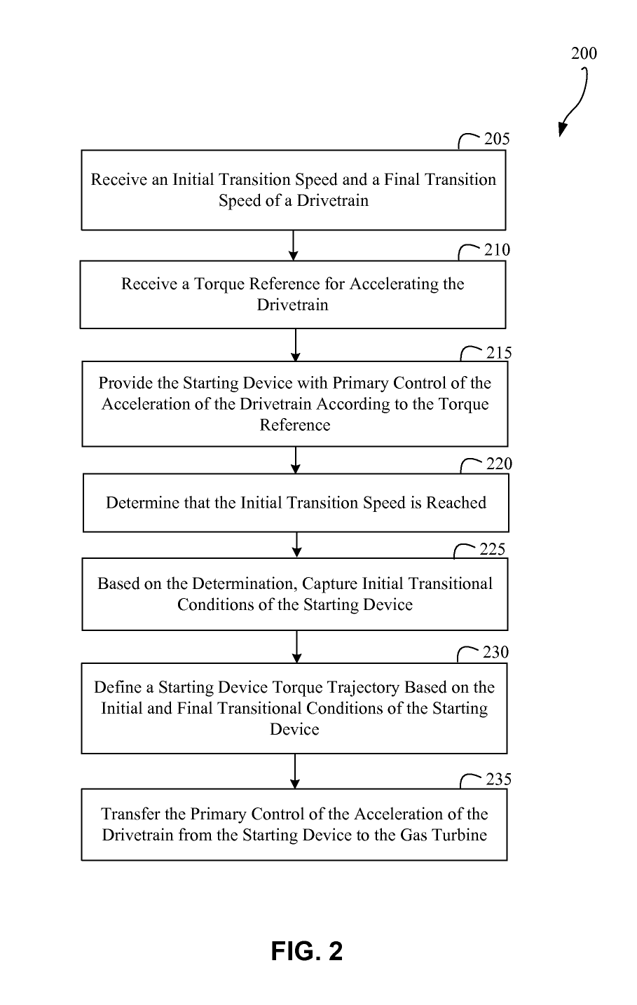

FIG. 2 depicts a process flow diagram illustrating an example method 200 for distributing torque reference, in accordance with an embodiment of the disclosure. The method 200 may be performed by processing logic that may comprise hardware (e.g., dedicated logic, programmable logic, and microcode), software (such as software run on a general-purpose computer system or a dedicated machine), or a combination of both. In one example embodiment, the processing logic resides at the controller 700, which may reside within a user device or a server. The controller 700 may comprise processing logic. It will be appreciated by one of ordinary skill in the art that instructions said to be executed by the controller 700 may, in fact, be retrieved and executed by one or more processors. The controller 700 may also include memory cards, servers, and/or computer discs. Although the controller 700 may be configured to perform one or more steps described herein, other control units may be utilized while still falling within the scope of various embodiments.

As shown in FIG. 2, the method 200 may commence in operation 205 with receiving an initial transition speed and a final transition speed of a drivetrain. The initial transition speed, for example, 65% of full speed, may be the speed when the turbine assumes full control and the transitions of torque contributions between the starting device and the turbine starts. The final transition speed, for example, 85% of full speed, may correspond to elimination of the torque contribution of the starting device. After the final transition speed is achieved, the turbine may continue accelerating the drivetrain to full speed. The values of the initial transition speed and final transition speed may be set by an operator.

In operation 210, a torque reference for accelerating the drivetrain may be received. The torque reference may define the overall torque to be applied to the drivetrain during the entire acceleration processes.

In operation 215, primary control of the acceleration of the drivetrain may be provided to the starting device. The starting device may accelerate the drivetrain according to the torque reference received in operation 210. While the starting device accelerates the drivetrain, the turbine may be ignited but provide little or no torque to the overall torque used to accelerate the drivetrain. The acceleration may continue until the initial transition speed received in operation 205 is reached.

In operation 220, the controller may determine that the initial transition speed is reached. In some example embodiments, the initial transition speed may be 65% of full speed. When the drivetrain reaches the initial transition speed, primary control of the acceleration of the drivetrain may be transferred from the starting device to the gas turbine. As mentioned above, in some example embodiments, the gas turbine may be maintained at a minimum operating state before the initial transition speed is reached.

In operation 225, the controller may capture initial transitional conditions of the starting device upon the drivetrain reaching the initial transition speed. The initial transitional conditions may include, for example, a starting device torque and a derivative of the starting device torque with respect to a speed of the drivetrain.

In operation 230, a starting device torque trajectory may be defined. To define the starting device torque trajectory a transitioning torque function (for example, a polynomial function of the third order) may be used. The transitioning torque function may be based on the initial final conditions (as received) and final conditions (desired final torque and torque with respect to speed of the drivetrain contributions) of the starting device. In case of a polynomial of the third order, the four boundary conditions can be used to obtain coefficients for the polynomial function.

In operation 235, the primary control of the acceleration of the drivetrain may be transferred from the starting device to the gas turbine. Once the primary control is transferred, the starting device may follow the starting device torque trajectory while the gas turbine maintains the primary control of the acceleration according to the torque reference.

The starting device torque trajectory may provide for gradual decrease in the torque contribution of the starting device as the gas turbine contribution increases.

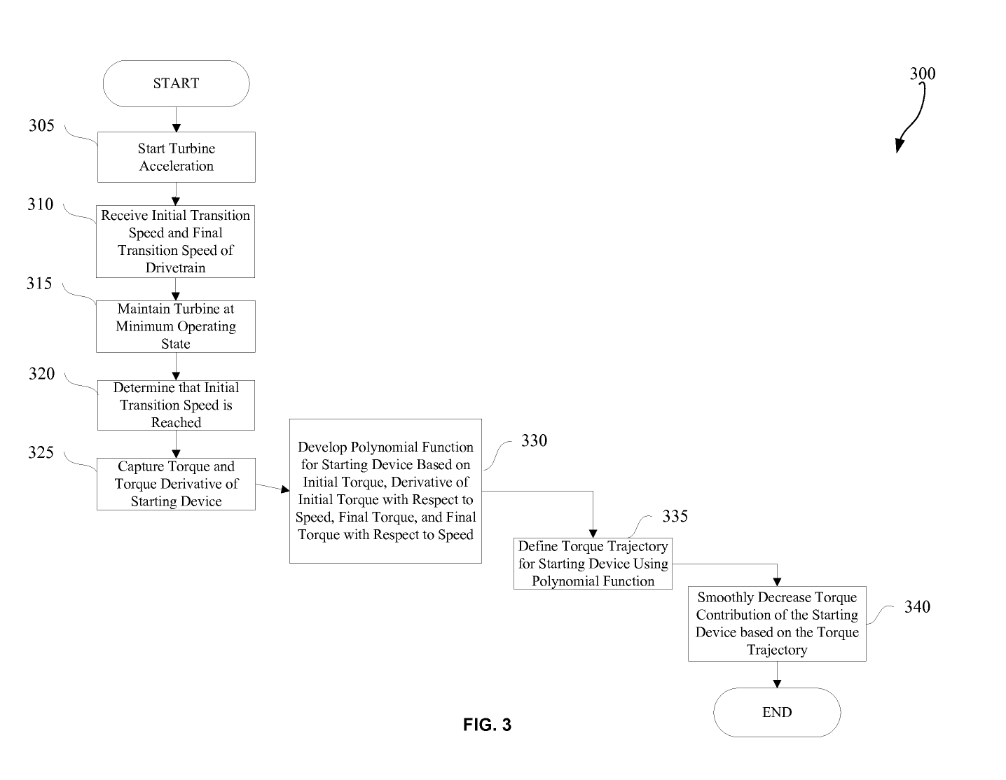

FIG. 3 depicts a process flow diagram illustrating an example method 300 for distributing torque contribution between a gas turbine and a starting device during acceleration of a drivetrain, in accordance with an embodiment of the disclosure.

A gas turbine startup may comprise a sequence of operations, such as ignition, acceleration, synchronization, and loading. During the initial operations, the starting device may be the sole torque contributor to the acceleration of the drivetrain of the gas turbine. Then, the gas turbine may start contributing to the overall torque. During the final operations of the startup process, the gas turbine may provide the majority of the torque driving the drivetrain. The transition of the overall control from the starting device to the gas turbine may take place when the drive train speed reaches a specific value, which may be referred to as an initial transition speed.

The method 300 may commence with the controller starting the turbine acceleration process in operation 305. In operation 310, the controller may receive initial and final transition speeds. The initial and final transition speeds may be defined by an operator of the gas turbine. Additionally, the controller may receive a torque reference for accelerating the drivetrain which defines the overall torque provided to the drivetrain during the startup process. Since the turbine may not contribute any torque in the beginning of the startup process, the starting device may be the sole contributor in accelerating the drivetrain according to the torque reference. Thus, at this stage, the primary control of the acceleration is provided to the starting device. The turbine may be maintained at a minimum operating speed in operation 315.

In operation 320, the controller may determine that the initial transition speed is reached. The initial transition speed, for example, 65% of full speed, may be sufficient for sustaining gas turbine operations and to continue the acceleration according to the acceleration profile.

A starting device torque and a derivative of the starting device torque with respect to the speed of the drivetrain may be captured in operation 325. These initial conditions along with target final conditions (final torque and derivative of final torque with respect to speed) may be used to develop a polynomial function in operation 330. In some example embodiments, the polynomial function may include a third order polynomial function.

Using the polynomial function, a torque trajectory for the drivetrain of the gas turbine may be defined in operation 335. The torque trajectory may define the starting device output during the transition phase, that is, from the initial transition speed to the final transition speed. During this transition phase, the gas turbine may be in full acceleration control, adjusting fuel flow to maintain the overall torque to the drivetrain.

In operation 340, the controller may smoothly ramp off the torque contribution of the starting device according to its torque trajectory. Once the final transition speed is reached, the gas turbine may continue acceleration of the drivetrain according to the overall torque trajectory.

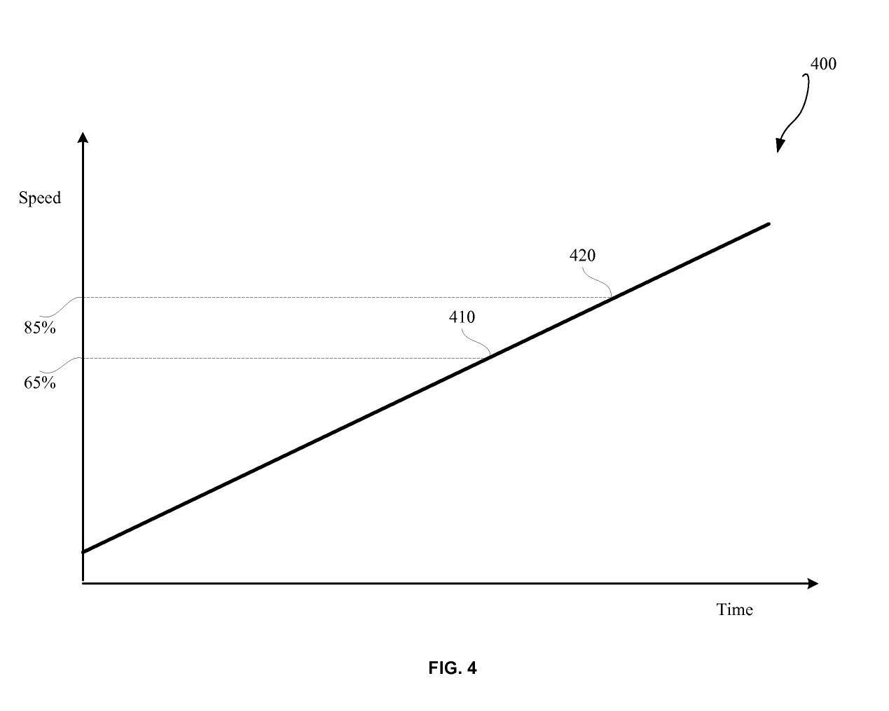

FIG. 4 depicts a representation of an example gas turbine acceleration path 400, in accordance with an embodiment of the disclosure. According to the method 200 for distributing torque contribution described above with reference to FIG. 2, a transition of the primary control of acceleration from the starting device to the gas turbine may take place at the initial transition speed 410. The transition speed range may be defined by an operator and in some example embodiments may include a range from an initial transition speed (for example, 65% of full speed) to a final transition speed (for example, 85% of full speed). The initial and final transition speeds may be defined and modified by the operator depending on various conditions. The initial and final transition speeds may determine the torque trajectory of the starting device.

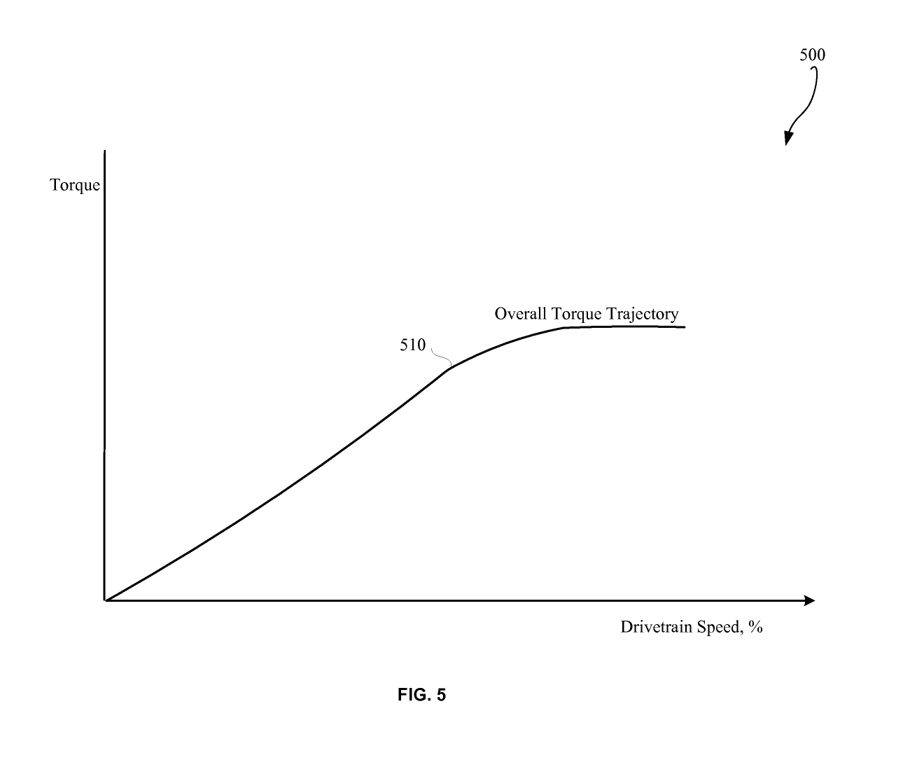

FIG. 5 illustrates an overall torque path 500, in accordance with an example embodiment of the disclosure. An overall torque trajectory 510 may represent a combined torque from the starting device and the gas turbine. The overall torque trajectory 510 may be provided by the controller in the beginning of the startup process.

Initially, only the starting device contributes to the overall torque trajectory 510 as the gas turbine does not provide any (or very little) torque at low drivetrain speeds. As the drivetrain speed increases, the gas turbine capability to produce torque increases. However, the gas turbine may be still be maintained at a minimum operating state before the initial transition speed is reached to ensure smooth transition of the primary control from the starting device to the gas turbine.

When the initial transition speed is reached, initial transitional conditions may be received to develop a transitioning torque function such as, for example, a third order polynomial function. Using the transitioning torque function, a starting device torque trajectory may be defined. The transitioning torque function may be designed to eliminate torque contribution of the starting device when the final transition speed of the drivetrain is reached. Thus, the contribution of the starting device may follow the transitioning torque function. With the decreasing contribution of the starting device, the contribution of the gas turbine may increase to maintain the overall torque trajectory.

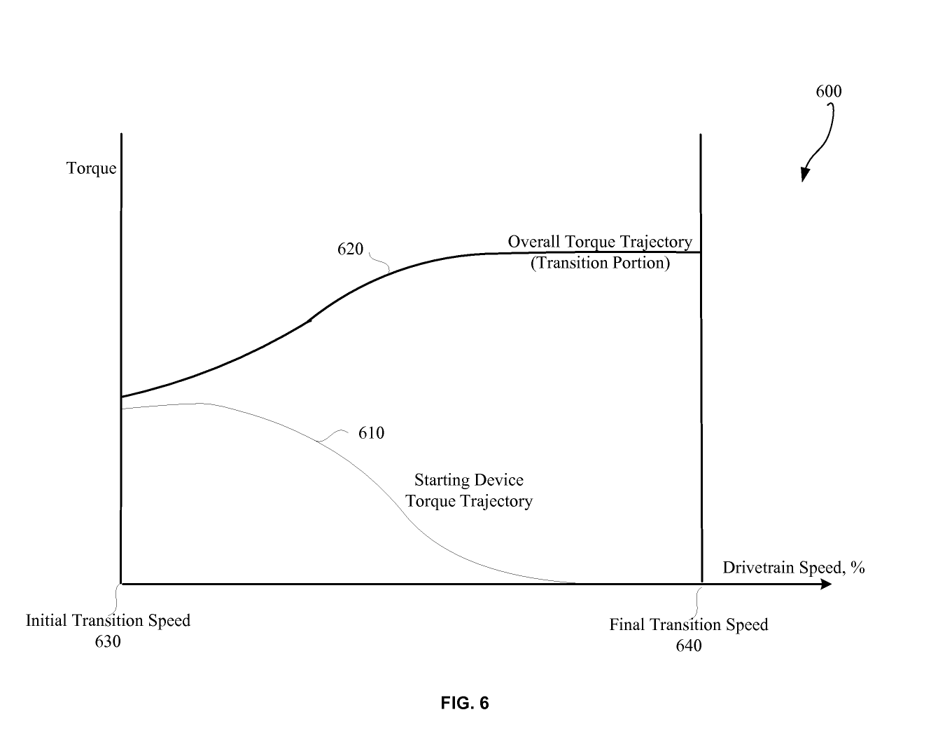

FIG. 6 illustrates overall and starting device torque paths during the transition portion of a gas turbine startup, in accordance with an embodiment of the disclosure. The overall torque trajectory (transition portion) 620 may represent combined torque from the starting device and the gas turbine during the transition portion of the gas turbine startup. A starting device torque trajectory 610 represents a trajectory to be followed by the starting device.

As already mentioned above, to define the starting device torque trajectory 610 a transitioning torque function may be used. The starting device torque trajectory 610 may be designed to eliminate torque contribution of the starting device when a final transition speed 640 of the drivetrain is reached.

According to the starting device torque trajectory 610, the torque of the starting device eventually decreases (even though it may increase initially), whereas the overall torque trajectory 620 continues driving the increase in the speed of the drivetrain.

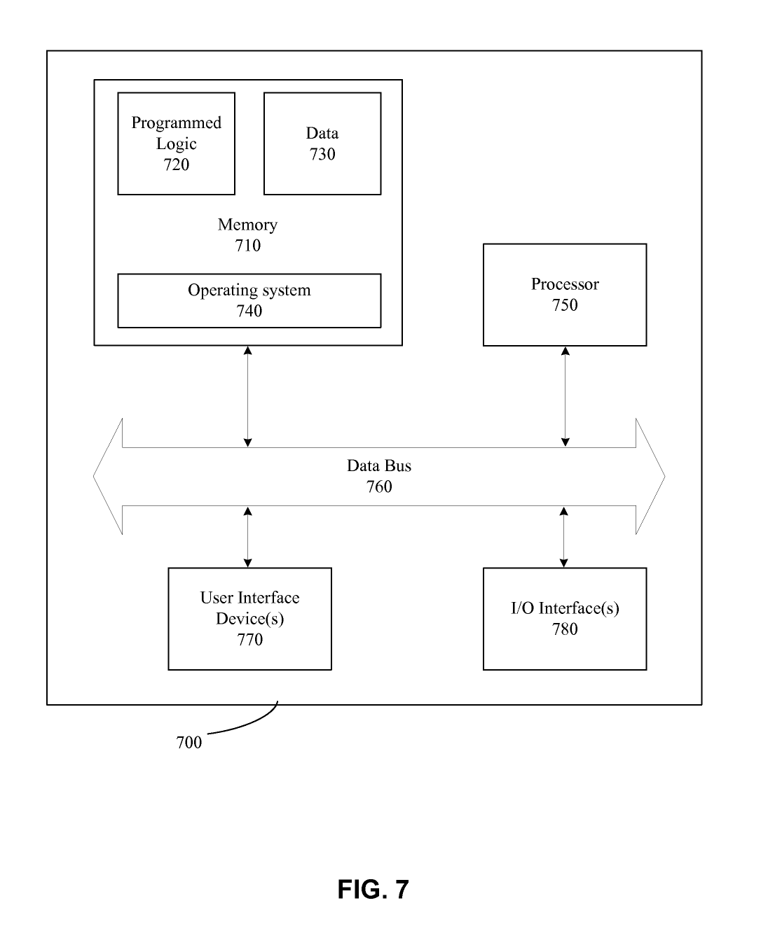

FIG. 7 depicts a block diagram illustrating a controller 700 for controlling a gas turbine in accordance with an embodiment of the disclosure. More specifically, the elements of the controller 700 may be used to dynamically distribute torque contribution between a gas turbine and a starting device during acceleration of a drivetrain. The controller 700 may include a memory 710 that stores programmed logic 720 (e.g., software) and may store data, such as an initial transition speed of the drivetrain, a final transition speed of the drivetrain, a torque reference for accelerating the drivetrain, initial transitional conditions of the starting device, and the like. The memory 710 also may include an operating system 740. A processor 750 may utilize the operating system 740 to execute the programmed logic 720, and in doing so, also may utilize the data 730. A data bus 760 may provide communication between the memory 710 and the processor 750. Users may interface with the controller 700 via at least one user interface device 770 such as a keyboard, mouse, control panel, or any other devices capable of communicating data to and from the controller 700. The controller 700 may be in communication with the gas turbine online while operating, as well as in communication with the gas turbine offline while not operating, via an I/O Interface 780. More specifically, one or more of the controllers 700 may carry out methods described with reference to FIGS. 2-3, including an initial transition speed and a final transition speed of the drivetrain, receiving a torque reference for accelerating the drivetrain; providing the starting device with primary control of the acceleration, determining that the initial transition speed is reached, based on the determination, capturing initial transitional conditions of the starting device, defining a torque trajectory of the starting device based on the initial transitional conditions and final transition conditions of the starting device, and transferring the primary control of the acceleration of the drivetrain from the starting device to the gas turbine. Additionally, it should be appreciated that other external devices or multiple other gas turbines may be in communication with the controller 700 via the I/O Interface 780. In the illustrated embodiment, the controller 700 may be located remotely with respect to the gas turbine; although, it may be co-located or even integrated with the gas turbine. Further, the controller 700 and the programmed logic 720 implemented thereby may include software, hardware, firmware, or any combination thereof. It should also be appreciated that multiple controllers 700 may be used, whereby different features described herein may be executed on one or more different controllers 700.

Accordingly, embodiments described herein allow dynamically distributing torque contribution between a gas turbine and a starting device during acceleration of a drivetrain, thus providing a smooth transition between torque contribution from the starting device to the gas turbine.

References are made to block diagrams of systems, methods, apparatuses, and computer program products according to example embodiments. It will be understood that at least some of the blocks of the block diagrams, and combinations of blocks in the block diagrams, respectively, may be implemented at least partially by computer program instructions. These computer program instructions may be loaded onto a general purpose computer, special purpose computer, special purpose hardware-based computer, or other programmable data processing apparatus to produce a machine, such that the instructions, which execute on the computer or other programmable data processing apparatus, create means for implementing the functionality of at least some of the blocks of the block diagrams, or combinations of blocks in the block diagrams discussed.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks. The computer program instructions may also be loaded onto a computer or other programmable data processing apparatus to cause a series of operational steps to be performed on the computer or other programmable apparatus to produce a computer implemented process, such that the instructions that execute on the computer or other programmable apparatus provide steps for implementing the functions specified in the block or blocks.

One or more components of the systems and one or more elements of the methods described herein may be implemented through an application program running on an operating system of a computer. They also may be practiced with other computer system configurations, including hand-held devices, multiprocessor systems, microprocessor based, or programmable consumer electronics, mini-computers, mainframe computers, etc.

Application programs that are components of the systems and methods described herein may include routines, programs, components, data structures, and so forth that implement certain abstract data types and perform certain tasks or actions. In a distributed computing environment, the application program (in whole or in part) may be located in local memory, or in other storage. In addition, or in the alternative, the application program (in whole or in part) may be located in remote memory or in storage to allow for circumstances where tasks are performed by remote processing devices linked through a communications network.

Many modifications and other embodiments of the example descriptions set forth herein to which these descriptions pertain will come to mind having the benefit of the teachings presented in the foregoing descriptions and the associated drawings. Thus, it will be appreciated the disclosure may be embodied in many forms and should not be limited to the example embodiments described above. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed is:

1. A method for distributing torque contribution between a gas turbine and a starting device during acceleration of a drivetrain, the method comprising:
receiving an initial transition speed and a final transition speed of the drivetrain;
receiving a torque reference for accelerating the drivetrain;
providing the starting device with primary control of the acceleration, the acceleration to be conducted according to the torque reference;
determining that the initial transition speed is reached;
based at least in part on the determination, capturing one or more initial transitional conditions of the starting device;
defining a torque trajectory of the starting device based at least in part on the one or more initial transitional conditions and final transition conditions of the starting device, the starting device torque trajectory designed to eliminate torque contribution of the starting device when the final transition speed of the drivetrain is reached; and
transferring the primary control of the acceleration of the drivetrain from the starting device to the gas turbine, wherein the starting device follows the starting device torque trajectory while the gas turbine maintains the primary control of the acceleration according to the torque reference.

2. The method of claim 1, wherein the gas turbine is maintained at a minimum operating state before the initial transition speed is reached.

3. The method of claim 1, wherein the one or more initial transitional conditions comprise a starting device torque and a derivative of the starting device torque with respect to a speed of the drivetrain.

4. The method of claim 1, wherein the torque trajectory of the starting device comprises a transitioning torque function.

5. The method of claim 4, wherein the transitioning torque function comprises a polynomial function based at least in part on the one or more initial transitional conditions.

6. The method of claim 5, wherein the polynomial function comprises a third order polynomial function.

7. The method of claim 1, wherein the starting device comprises one or more of the following: a motor, a load commutated inverter, and a torque converter.

8. The method of claim 1, wherein the drivetrain comprises a shaft.

9. The method of claim 1, wherein the starting device modulates a torque output according to the torque reference.

10. The method of claim 1, wherein the primary control of the acceleration is maintained by adjusting a fuel flow to the gas turbine.

11. A system for distributing torque contribution between a gas turbine and a starting device during acceleration of a drivetrain, the system comprising:
a controller; and
a processor communicatively coupled to the controller and configured to:
receive an initial transition speed and a final transition speed of the drivetrain;
receive a torque reference for accelerating the drivetrain;
provide the starting device with primary control of the acceleration of the drivetrain according to the torque reference;
determine that the initial transition speed is reached;
based at least in part on the determination, capture one or more initial transitional conditions of the starting device;
define a torque trajectory of the starting device based at least in part on the one or more initial transitional conditions and the final transition speed of the drivetrain, the starting device torque trajectory designed to eliminate torque contribution of the starting device when the final transition speed of the drivetrain is reached; and
transfer the primary control of the acceleration of the drivetrain from the starting device to the gas turbine, wherein the starting device follows the torque trajectory while the gas turbine maintains the primary control of the acceleration according to the torque reference.

12. The system of claim 11, wherein the controller is further configured to control the gas turbine.

13. The system of claim 11, wherein the drivetrain comprises a shaft.

14. The system of claim 11, wherein the starting device comprises one or more of the following: a motor, a load commutated inverter, and a torque converter.

15. The system of claim 11, wherein the one or more initial transitional conditions comprise a starting device torque and a derivative of the starting device torque with respect to a speed of the drivetrain.

16. The system of claim 11, wherein the torque trajectory of the starting device comprises a transitioning torque function.

17. The system of claim 16, wherein the transitioning torque function comprises a polynomial function based at least in part on the one or more initial transitional conditions.

18. The system of claim 17, wherein the polynomial function comprises a third order polynomial function.

19. The system of claim 11, wherein the starting device modulates a torque output according to the torque reference.

20. A system for distributing torque contribution between a gas turbine and starting device during acceleration of a drivetrain, the system comprising:
the gas turbine;
the starting device coupled to the gas turbine;
a controller configured to control the gas turbine; and
a processor communicatively coupled to the controller and configured to:
receive an initial transition speed and a final transition speed of the drivetrain;
receive a torque reference for accelerating the drivetrain;
provide the starting device with primary control of the acceleration of the drivetrain according to the torque reference;
determine that the initial transition speed is reached;
based at least in part on the determination, capture one or more initial transitional conditions of the starting device;
define a torque trajectory of the starting device as a polynomial function based at least in part on the one or more initial transitional conditions and the final transition speed of the drivetrain, the torque trajectory designed to eliminate torque contribution of the starting device when the final transition speed of the drivetrain is reached; and
transfer the primary control of the acceleration of the drivetrain from the starting device to the gas turbine, wherein the starting device follows the starting device torque trajectory while the gas turbine maintains the primary control of the acceleration according to the torque reference.
